(19) United States
(12) Patent Application Publication
(10) Pub. No.: US 2014/0001015 A1
(43) Pub. Date: Jan. 2, 2014

(54) LOCKING SWITCH ASSEMBLY AND MANUFACTURE OF LOCKING COMPONENT

(71) Applicant: Mark Roy Slack, Nottingham (GB)

(72) Inventor: Mark Roy Slack, Nottingham (GB)

(73) Assignee: Cooper Medc limited, Nottingham (GB)

(21) Appl. No.: 14/006,255

(22) PCT Filed: Mar. 21, 2012
(86) PCT No.: PCT/GB12/00262

§ 371 Date: Sep. 19, 2013

(30) Foreign Application Priority Data
Mar. 21, 2011 (GB) 1104753.7

(51) Int. Cl. H01H 9/20

(52) U.S. Cl. CPC H01H 9/20
USPC 200/43.11; 219/121.71

(57) ABSTRACT

A switching assembly having: a switching member movable between first and second positions, the switching member having a locking element; and locking means for engaging said switching member when it is in the second position to lock the switching member in the second position; characterized in that the locking means is formed of a sheet of resiliently deformable material to have one or more locking elements for complementary engagement with one or more locking elements provided by the switching member when the switching member is in the second position

The present invention relates to a lockable switch assembly, in particular to the means for locking the switch in at least one position.

Locking switches are widely known. An example of a lockable switch might be a power cut-off switch, which is used to break a high power circuit in the event of crisis, e.g. a fire. Another example might be a switch for activating an alarm.

However, conventional lockable switches typically require complicated components, because once the switch is activated and placed in the locked position it is often critical that the switch remains there. Also, it is often critical that the switch is reliably operable despite its lockable nature. This is especially true of safety switches such as power cut-off switches and alarm switches.

Manufacturing components for such conventional lockable switches proves to be expensive. Furthermore, due to the complex nature of conventional components and their mutual arrangement, they are liable to failure. If failure does occur, the repair and replacement of the component parts can be time consuming and expensive.

The present invention is made in the light of at least the foregoing problems.

Accordingly, the present invention preferably provides a switching assembly having: a switching member movable between first and second positions, the switching member having a locking element; and locking means for engaging said switching member when it is in the second position to lock the switching member in the second position; characterized in that the locking means is formed of a sheet of resiliently deformable material to have one or more locking elements for complementary engagement with one or more locking elements provided by the switching member when the switching member is in the second position.

Thus, the present invention provides a switching assembly which allows for the switching member to be locked in at least one position by virtue of the interaction of the switching member with an uncomplicated and inexpensively manufactured locking means. The locking means can be mass produced on a large scale for a relatively minimal cost, because it is preferred that the locking means be formed of inexpensive sheet metal, e.g. steel, stainless steel or aluminium.

Furthermore, it is preferred that the locking means be shaped by punching or laser cutting from the larger sheet of e.g. metal. Preferably, the sheet, of e.g. metal, has an average thickness of no more than 3 mm, preferably no more than 2 mm, preferably of between 500 μm and 1500 μm and even more preferably of between 1000 μm and 1500 μm.

Preferably, the locking means is a planar body, i.e. a flat body.

Preferably, the switching member is pivotable between the first and second positions.

More preferably, the switching member includes a truncated crest arranged around the pivoting axis of the switching member for engagement with a locking element of the locking means, wherein the truncated crest is arranged such that movement of the switching member from the first position to the second position causes the crest to progressively deform the locking means locking element from its starting position until the switch member reaches the second position whereupon the locking means locking element reaches the truncated end of the crest and is able to resile towards its starting position to engage the switching member locking element, and thereby lock the switching member in the second position.

Accordingly, the present invention provides a reliably lockable switching assembly, in which the locking means is readily mass-producable at low cost.

The switching member locking element is preferably provided by the truncated end of the crest.

Preferably, when the switching member is in the second position, the locking means locking element abuts against a wall formed by the truncated end of the crest, thereby preventing the switching member from being returned from the second position to the first position.

The truncated end of the crest may form a wall substantially parallel to the pivoting axis of the switching member. The crest is preferably arranged around the pivoting axis of the switching member to project progressively radially outward of the pivoting axis, therefore as the switching member is pivoted the crest is preferably able to progressively deform the locking means.

A respective truncated crest may be provided for each locking means locking element.

The locking means preferably includes a stabilizing element for engagement with a complementary stabilizing element provided by the switching member, the respective stabilizing elements cooperating to urge the switch to reside at the first position or the second position. The present invention therefore preferably provides a bi-stable switching assembly. However, the stability may be of a higher order, e.g. there may be more than two stable positions. For brevity, two stable positions (for example, described as providing a bi-stable switching assembly) will be used to describe the present invention, but the description of the invention herein should not be construed as being limited to such.

The respective stabilizing elements cooperate to urge the switch to reside at the first position or the second position depending on the relative location of the switching member between the two positions.

The locking means stabilizing element may be provided in the form of a deformable finger projecting from the locking means. The switching member stabilizing element may be provided in the form of a ridge projecting from the switching member, the ridge preferably having a pair of flat surfaces mutually angled with respect to one another to engage stably the locking means stabilizing element respectively in the first and second positions. The flat surfaces are preferably separated by an apex region.

Deformation of the locking means stabilizing element, by moving the switching member to a location between the first and second positions, may result in the locking means stabilizing element cooperating with the apex region to urge the switching member to the first or second position.

The locking means is preferably provided in a general U shape, the tines forming the locking means locking element(s) and the locking means stabilizing element(s).

The locking means preferably includes four tines, the tines forming a pair of locking elements and a pair of stabilizing elements. The stabilizing elements may be formed to be outermost and to either side of the pair of locking elements.

The locking means is preferably provided in a general U shape, the tines forming the locking means locking element(s).

Preferably, the locking means is formed of sheet metal. The locking means may be formed of sheet metal punched to the desired shape. The locking means may however be formed of sheet metal laser cut to the desired shape. The locking means may be formed of aluminium, steel or stainless steel.

Preferably, the sheet has an average thickness of between 1000 μm and 1500 μm. The switching member is preferably releasable from the locked second position by deformation of the or each locking means locking element so as to allow the truncated crest to pass back passed (to pass back by) the locking means locking element(s).

One or more apertures are preferably provided in the switching assembly to permit a deforming member to engage and deform the or each locking means locking element sufficiently to allow the switching member to be returned to the first position.

In another aspect, the present invention preferably provides a method of manufacturing a locking means as described herein, the method including the step(s) of punching and/or laser cutting a sheet of metal e.g. to provide a locking means having one or more of said locking elements.

The method preferably further includes the step(s) of punching and/or laser cutting the sheet of metal e.g. to provide a locking means having one or more of said stabilizing elements.

The present invention will now be described in more detail by way of example only, with reference to the accompanying figures, in which:

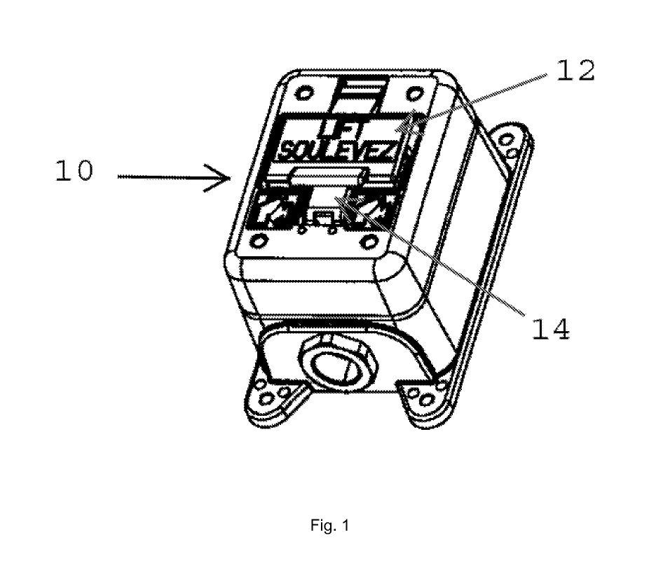

FIG. 1 shows a switching assembly according to the present invention;

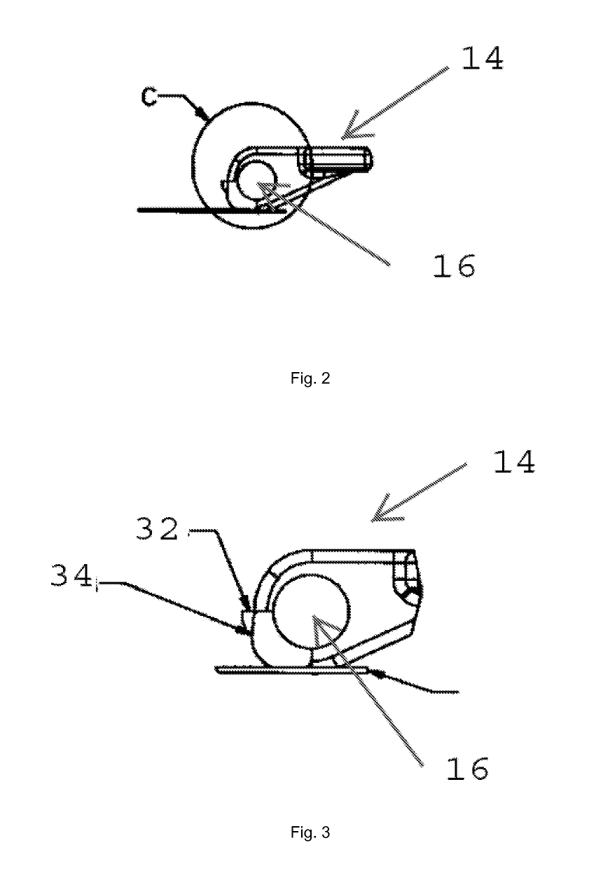

FIG. 2 shows a side view of a pivotable switch according to the present invention;

FIG. 3 shows a close up view of the area labeled “C” in FIG. 2;

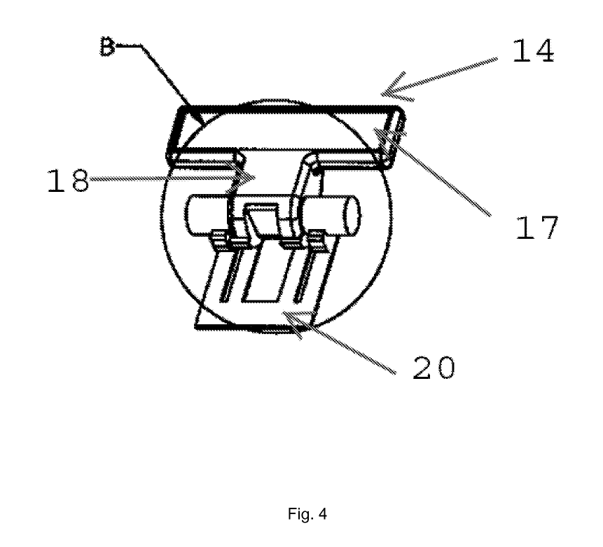

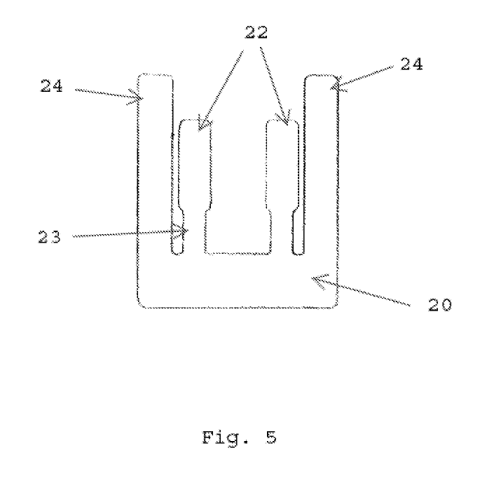

FIG. 4 shows a perspective view of a switch and locking means according to the present invention;

FIG. 5 shows a plan view of a locking means according to the present invention;

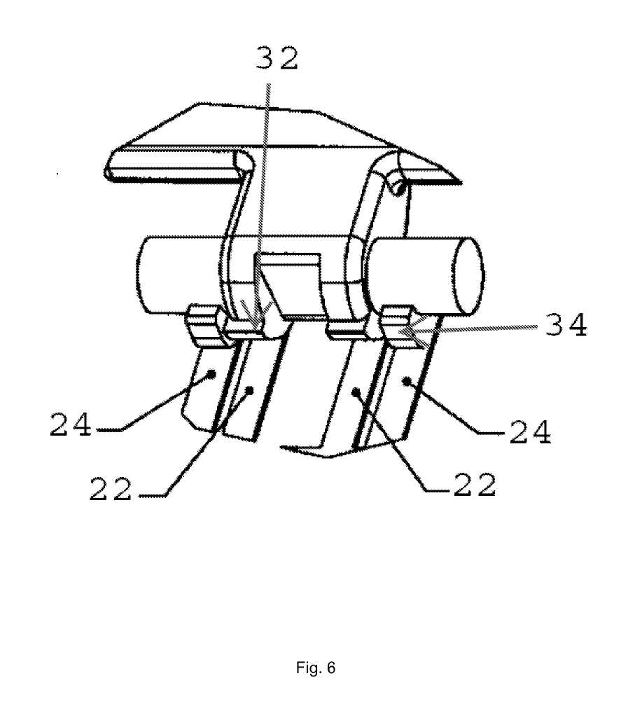

FIG. 6 shows a close up view of the area labeled “B” in FIG. 4;

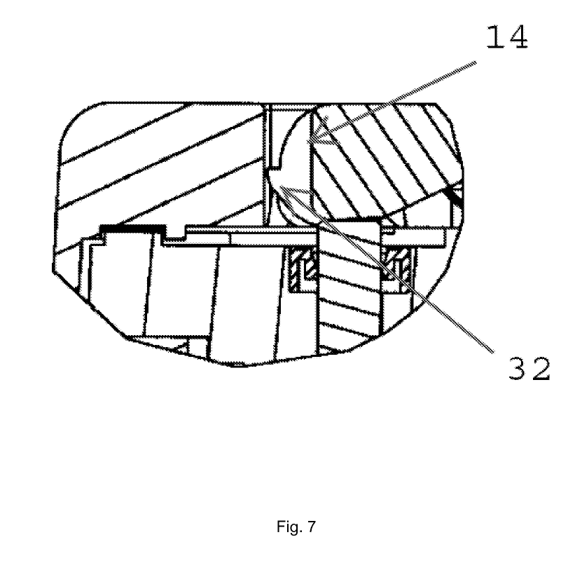

FIG. 7 shows a side sectional view of a switch and locking means according to the present invention mounted in a switching assembly according to the present invention;

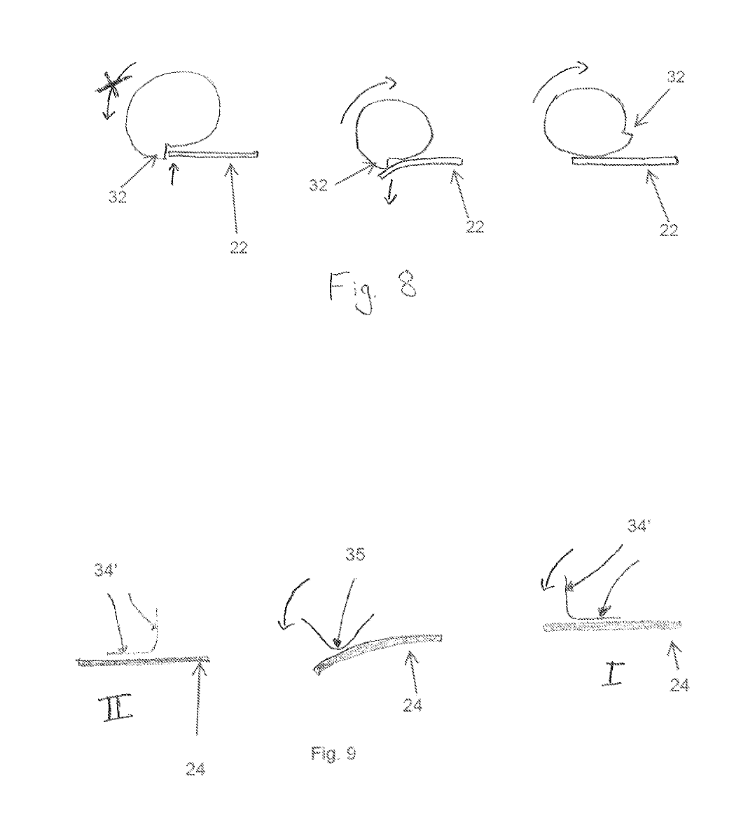

FIG. 8 shows a schematic of how the switch and the locking means interact to provide a locking switching assembly according to the present invention; and

FIG. 9 shows a schematic of how the switch and the locking means interact to provide a bi-stable (or multi-stable) switching assembly according to an aspect of the present invention.

FIG. 1 shows a switching assembly 10 according to an aspect of the present invention. The switching assembly 10 includes a switch 14, which may be provided in the form of a pivotable lever switch. The switching assembly 10 may include a switch guard 12, to protect the switch 14 from damage and/or accidental use. The switch guard may be provided in the form of a movable (e.g. pivotable) guard which is movable to provide user access to the switch. The switch guard may be urged to usually reside in a guard position to prevent access to the switch and thus prevent the switch being used. The urging force may be provided by a resiliently deformable member, e.g. a spring (not shown).

The switch 14 is preferably movable (pivotable) about a movement (pivot) axis 16, as shown in FIG. 2, which is a side view of a pivotable switch 14 according to the present invention. In FIG. 2 the pivot axis is envisaged to reside substantially (or approximately) at the centre of the circle generally indicated by reference 16 and to extend normal to the plane of the image. Circle “C” shown in FIG. 2 represents the area of the “zoomed in” image of FIG. 3, in which the switch 14 can be seen from the side in more detail.

FIG. 4 is a perspective view of the switch 14, mounted together with a locking means 20 according to the present invention. The switch preferably includes a handle 17, which preferably extends laterally from the lever body 18 of the switch to provide a large grippable area for the user. Area “B” in FIG. 4 is reproduced in larger scale in FIG. 6, which is discussed below.

FIG. 5 shows the form of a preferred locking means 20 according to the present invention. Although the body 20 is referred to here as a locking means, it should be noted that its function is not necessarily limited to contributing to locking the switch 14 into a particular position. As will be discussed below it also/alternatively can act as an indexing means to provide two or more indexed positions for the switch 14.

Locking means 20 according to the present invention preferably include at least one, but more preferably two (or more), locking plates 22. The locking plate(s) 22 are resiliently deformable, e.g. resiliently deformable out of a plane in which the locking means 20 usually resides.

Each locking plate 22 is intended to engage with a respective locking ridge 32 provided on the switch 14 as shown in FIG. 6. The locking ridge 32 is preferably formed to project progressively radially around the pivoting axis of the switch 14, e.g. as shown in the cross-sectional view provided in FIG. 7, to form a crest around the pivoting axis of the switch. The ridge, or crest, is preferably truncated. Therefore, as the switch 14 is pivoted about its pivot axis, the projection of ridge (or crest) 14 progressively engages with and deforms the resiliently deformable locking plate 22 preferably until the truncated end of the ridge passes by the end of the locking plate as shown in FIG. 8. Passing by the truncated end of the ridge 32 allows the locking plate 22 to resile (return) towards its starting position. It may resile to its starting position. In resiling towards its starting position the locking plate 22 moves in behind the truncated end of the ridge 32. This preferably prevents the switch from being pivoted back in the opposite direction because the truncated end abuts against an end of the locking plate 22, thereby locking the switch in position. This action is reproduced schematically in FIG. 8. Preferably, the truncated end of the ridge forms an abrupt wall, against which the locking plate 22 is abuttable, thereby preventing the switch from being moved (pivoted) in the reverse direction—the switch being locked in position.

The ability of the locking plate(s) 22 to deform can be enhanced by weakening a portion of the plate(s), by e.g. waisting the plates. For example a relatively narrow portion 23 as shown in FIG. 5 may be formed in the or each plate.

To unlock the switch, a switching assembly according to the present invention may include means permitting a user to deform the locking plate(s) 22 sufficiently to allow the switch to be moved (pivoted) in the reverse direction—in other words, to allow the truncated end of the ridge to pass back over the deformed locking plate and to permit the switch to be unlocked from its locked position and e.g. returned to its starting position. In a preferred embodiment, an aperture is provided in a housing of the switching assembly 10 through which a deforming member can access the locking plate(s) 22 to deform them sufficiently to allow the ridge(s) 32 to pass (back) by the locking plate(s). However, the assembly may be provided with integral deforming means, e.g. in the form of a movable body, the movement of which causes sufficient deformation of the locking plate(s) to allow the switch to be unlocked from its locked position.

The locking means may (alternatively or) additionally include one or more, but preferably two, indexing plates 24 e.g. for engagement with a respective indexing finger 34 provided on the switch 14. Preferably, the indexing finger(s) 34 are shaped to interact with the indexing plate(s) so that the switch is capable of stably residing in at least two positions. Preferably, when the switch is not residing in a stable position, the interaction of the indexing finger(s) 34 and indexing plate(s) 24 urges the switch to a stable position.

Preferably, the indexing finger(s) 34 are shaped to provide a bi-stable switch 14. Accordingly, an indexing finger 34 preferably has two stable indexing surfaces 34′, each of which interacts with the indexing plate 24 to stably hold the switch in a respective position. The indexing surfaces are separated by an intermediate surface 35, which interacts with the indexing plate to urge the switch to move to a stable indexed position. In a preferred embodiment, as shown in FIG. 9, the indexing finger has two indexing surfaces 34′ which preferably align with respective indexing plates 24. When the switch is in position one or position two, the switch is said to be indexed and the switch is in a stable position. However, when the switch is pivoted the intermediate surface 35 engages the indexing member 24 and deforms it. Due to the shape of the intermediate surface 35 and the resilient nature of the indexing member 24, the switch is unstable and is urged towards one or other of the stable indexed positions. Thus, in this preferred embodiment the switch is bi-stable. However, it is conceivable, that by providing more than two indexing surfaces, separated by a plurality of intermediate surfaces, a multi-stable or multi-indexed switch could be provided.

Furthermore, by arranging the ridge 32 with respect to the indexing surfaces, it would be possible to provide a multi-stable or multi-indexed switch which is uni-directional for one or more of the indexed positions. For example, a switch assembly may have a switch 14 having three indexing positions such that when the switch is moved from position one to two the switch can be returned to position one. However, when the switch is moved to position three, it is locked in place by the locking means.

At the core of a preferred aspect of the present invention, is the inexpensive and uncomplicated way in which the locking means 20 can be produced. The locking means 20 is preferably formed of a sheet of material, preferably an integral sheet of material. The sheet is preferably formed of sheet metal. The metal is preferably steel, stainless steel or aluminium. However, the locking means 20 may be formed of a polymeric material (preferably thermo-plastic but possibly thermo-set) and/or composite materials such as carbon fiber. To improve the resilience, e.g. the ability (memory') of the locking means to resile to its original configuration, the material may be heat treated. For example, if the material is steel, e.g. stainless steel, heat treating the material produces ‘spring steel’.

Sheet materials are easily handled and shaped. Advantageously, it is inexpensive and requires uncomplicated machining tools to form a locking means according to the present invention from sheet materials. For example, a locking means according to the present invention can be formed from a sheet material by punching and/or laser cutting and/or water jet cutting. If a suitable material is used, e.g. a polymeric material, then the locking means may be formed by injection molding and/or compression molding.

Preferably, the sheet from which the locking means 20 is formed has an average thickness of no more than 3 mm, preferably no more than 2 mm, preferably of between 500 μm and 1500 μm and even more preferably of between 1000 μm and 1500 μm. Preferably, the average thickness is 1500 μm. However, the locking means may be configured such that the section thickness varies along the length and/or width of the locking means to provide the required mechanical properties. This may be particularly desirable where the locking means is formed of a polymeric material.

The present invention has been described with reference to preferred embodiments. Modifications of these embodiments, further embodiments and modifications thereof will be apparent to the skilled person and as such are within the scope of the invention.

The invention includes the combination of the aspects and preferred features described except where such a combination is clearly impermissible or expressly avoided.

1. A switching assembly having:
a switching member movable between first and second positions, the switching member having a locking element; and
locking means for engaging said switching member when it is in the second position to lock the switching member in the second position; characterized in that
the locking means is formed of a sheet of resiliently deformable material to have one or more locking elements for complementary engagement with one or more locking elements provided by the switching member when the switching member is in the second position.

2. A switching assembly according to claim 1, wherein the switching member is pivotable between the first and second positions.

3. A switching assembly according to claim 2, wherein the switching member includes a truncated crest arranged around the pivoting axis of the switching member for engagement with a locking element of the locking means, and wherein
the truncated crest is arranged such that movement of the switching member from the first position to the second position causes the crest to progressively deform the locking means locking element from its starting position until the switch member reaches the second position, whereupon the locking means locking element reaches the truncated end of the crest and is able to resile towards its starting position to engage the switching member locking element.

4. A switching assembly according to claim 3, wherein the switching member locking element is provided by the truncated end of the crest.

5. A switching assembly according to claim 3 or 4, wherein when the switching member is in the second position, the locking means locking element abuts against a wall formed by the truncated end of the crest, thereby preventing the switching member from being returned from the second position to the first position.

6. A switching assembly according to claim 3, 4 or 5, wherein the truncated end of the crest forms a wall substantially parallel to the pivoting axis of the switching member.

7. A switching assembly according to any one of claims 3 to 6, wherein the crest is arranged around the pivoting axis of the switching member to project progressively radially outward of the pivoting axis.

8. A switching assembly according to any one of the preceding claims, wherein at least two locking means locking elements are provided.

9. A switching assembly according to claim 8 as dependent on any one of claims 3 to 7, wherein a respective truncated crest is provided for each locking means locking element.

10. A switching assembly according to any one of the preceding claims, wherein the locking means includes a stabilizing element for engagement with a complementary stabilizing element provided by the switching member, the respective stabilizing elements cooperating to urge the switch to reside at the first position or the second position.

11. A switching assembly according to claim 10, wherein the respective stabilizing elements cooperate to urge the switch to reside at the first position or the second position depending on the relative location of the switching member between the two positions.

12. A switching assembly according to claim 10 or 11, wherein the locking means stabilizing element is provided in the form of a deformable finger projecting from the locking means.

13. A switching assembly according to any one of claims 10 to 12, wherein the switching member stabilizing element is provided in the form of a ridge projecting from the switching member, the ridge having a pair of flat surfaces mutually angled with respect to one another to engage stably the locking means stabilizing element respectively in the first and second positions.

14. A switching assembly according to claim 13, wherein the flat surfaces are separated by an apex region.

15. A switching assembly according to claim 14, wherein deformation of the locking means stabilizing element, by moving the switching member to a location between the first and second positions, results in the locking means stabilizing element cooperating with the apex region to urge the switching member to the first or second position.

16. A switching assembly according to any one of claims 10 to 15, wherein the locking means is provided in a general U shape, the tines forming the locking means locking element(s) and the locking means stabilizing element(s).

17. A switching assembly according to claim 16, wherein the locking means includes four tines, the tines forming a pair of locking elements and a pair of stabilizing elements.

18. A switching assembly according to claim 17, wherein the stabilizing elements are formed to be outermost and to either side of the pair of locking elements.

19. A switching assembly according to any one of the preceding claims, wherein the locking means is provided in a general U shape, the tines forming the locking means locking element(s).

20. A switching assembly according to any one of the preceding claims, wherein the locking means is formed of sheet metal.

21. A switching assembly according to any one of the preceding claims, wherein the locking means is formed of sheet metal punched to the desired shape.

22. A switching assembly according to any one of the preceding claims, wherein the locking means is formed of sheet metal laser cut to the desired shape.

23. A switching assembly according to any one of the preceding claims, wherein the locking means is formed of aluminium, steel or stainless steel.

24. A switching assembly according to any one of the preceding claims, wherein the sheet has an average thickness of between 1000 μm and 1500 μm.

25. A switching assembly according to claim 3 or any claim dependent on claim 3, wherein the switching member is releasable from the locked second position by deformation of the or each locking means locking element so as to allow the truncated crest to pass back passed the locking means locking element(s).

26. A switching assembly according to claim 25, wherein one or more apertures are provided in the switching assembly to permit a deforming member to engage and deform the or each locking means locking element sufficiently to allow the switching member to be returned to the first position.

27. A method of manufacturing a locking means according to any one of claims 1 to 26, the method including the step of punching or laser cutting a sheet of metal to provide a locking means having one or more of said locking elements.

28. The method according to claim 27 as dependent on 21 or 22, further including the step of punching or laser cutting the sheet of metal to provide a locking means having one or more of said stabilizing elements.

29. A switching assembly substantially as described herein, with reference to the accompanying figures.

30. A locking means substantially as described herein, with reference to the accompanying figures.

31. A method of manufacturing a locking means as described herein, with reference to the accompanying figures.
